(19) United States
(12) Patent Application Publication
(10) Pub. No.: US 2011/0202974 A1
(43) Pub. Date: Aug. 18, 2011

(54) METHOD OF ACCESSING MEDICAL DATA AND COMPUTER SYSTEM FOR THE SAME

(75) Inventors: ERIC LEADER, Phoenix, AZ (US); Stanley Person, Mesa, AZ (US)

(73) Assignee: Carefx Corporation, Scottsdale, AZ (US)

(21) Appl. No.: 12/707,432

(22) Filed: Feb. 17, 2010

(51) Int. Cl. G06F 21/24; H04L 9/32; G06N 5/02

(52) U.S. Cl. 726/4; 726/28; 706/47

(57) ABSTRACT

Some embodiments disclose a method of accessing medical data from two or more data sources. The method can include: receiving a first request for first data about a first patient from a first requestor, the first request for the first data includes a request for information regarding at least one of a bone of the first patient, an organ of the first patient, or a body tissue of the first patient; retrieving first access information about the first patient; retrieving second access information about the first requestor; determining whether to grant access to the first data by the first requestor at least partially based on the first access information and the second access information; retrieving the first data from a first source of the two or more data sources; and if the first requestor is granted access to the first data, transforming the first data into a visual depiction and transmitting the visual depiction of the first data to the first requestor. Other embodiments are disclosed herein.

### FIELD OF THE INVENTION

This invention relates generally to a computer system and method for accessing medical data, and relates more particularly to a computer system configured to determine access rights to the medical data and provide access to the medical data to authorized users and methods for the same.

### DESCRIPTION OF THE BACKGROUND

In many commercial endeavors, a user of a computer system might want to share a set of data with other authorized users. For example, in the field of medicine, medical providers might want to share medical data with other medical providers who need access to the medical data to treat a patient. For example, the medical data can include patient information (such as name, sex, social security number, patient ID, primary physician, medical history, drug interactions, etc.), user information (such as user identification, password, etc.), encounter or visit information (such as date, encounter number, name of treating physician, etc.), observation information (such as diagnosis, blood test results, etc.), financial information (such as insurance coverage, billing history, etc.), or other types of information.

The healthcare industry recognizes the need for managing and sharing data, and in 1999, the Health Level Seven (HL7) published the first Clinical Context Object Workgroup (CCOW) standard (hereafter the “HL7 Protocol”) for context management. The HL7 Protocol defines a context management architecture (CMA) and processes for managing information describing a subject across a range of clinical and other healthcare-related computer applications. The nature of the HL7 Protocol is described, for example, in HL7 Context Management Standard, Version 1.5, which was ratified in May 2004.

While the HL7 Protocol allows context and data sharing, a medical provider's ability to access medical data held by other medical providers is still limited, and even if access can be obtained, the process of granting access is slow and cumbersome. For example, a patient is admitted to the emergency room of a hospital. The admitting physician may need the patient's medical data, but the hospital has never treated the patient before. Currently, the admitting physician would have to find out from the patient, the name of the patient's primary care physician, and/or the names of medical facilities where the patient has been treated. Assuming the admitting physician can obtain this information, the admitting physician would then have to: (1) contact the other doctor or medical facility; (2) convince the other doctor or medical facility of the identity of the admitting physician; (3) convince the other doctor or medical facility that he or she needs the medical data; and (4) have the medical data transferred to the hospital. This method of accessing medical data does not serve the patient well because it is slow, unreliable, and costly.

Accordingly, a need exists for a method and a system that can determine who is authorized to access data and that can allow authorized users easy and quick access to data stored in other systems.

### BRIEF DESCRIPTION OF THE DRAWINGS

To facilitate further description of the embodiments, the following drawings are provided in which:

FIG. 1 illustrates a block diagram of a computer system configured to access medical data from two or more medical data sources and display the medical data to a requestor, according to a first embodiment;

FIG. 2 illustrates a flow chart for an embodiment of a method of providing a patient-provider index, according to the first embodiment;

FIG. 3 illustrates an example of accessing the medical data in the transaction, according to the first embodiment;

FIG. 4 illustrates a flow chart for an embodiment of a method of providing, building, or modifying a patient directive index, according to the first embodiment;

FIG. 5 illustrates a flow chart for an embodiment of a method of providing, building, or modifying one or more access rules, according to the first embodiment;

FIG. 6 illustrates an example of a rules input window, according to the first embodiment;

FIG. 7 illustrates a flow chart for an embodiment of a method of receiving login information from a requestor and validating an identity of the requestor, according to the first embodiment;

FIG. 8 illustrates a flow chart for an embodiment of a method of accessing medical data from two or more data sources, according to the first embodiment;

FIG. 9 illustrates a flow chart for an embodiment of an activity of applying the access rules and patient directives, according to the first embodiment;

FIG. 10 illustrates a flow chart for an embodiment of a procedure of processing an access rule, according to the first embodiment;

FIG. 11 illustrates a computer that is suitable for implementing an embodiment of computer system of FIG. 1; and

FIG. 12 illustrates a representative block diagram of an example of the elements included in the circuit boards inside a chassis of the computer of FIG. 11.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable

### DETAILED DESCRIPTION OF EXAMPLES OF EMBODIMENTS

Some embodiments disclose a method of accessing medical data from two or more data sources. The method can include: receiving a first request for first data about a first patient from a first requestor, the first request for the first data includes a request for information regarding at least one of a bone of the first patient, an organ of the first patient, or a body tissue of the first patient; retrieving first access information about the first patient; retrieving second access information about the first requestor; determining whether to grant access to the first data by the first requestor at least partially based on the first access information and the second access information; retrieving the first data from a first source of the two or more data sources; and if the first requestor is granted access to the first data, transforming the first data into a visual depiction and transmitting the visual depiction of the first data to the first requestor.

The same or different embodiments can disclose a method of providing a patient-provider index. The method can include: accessing first medical data for a first patient, the first medical data regarding one or more medical services provided to the first patient; extracting first information from the first medical data, the first information regarding one or more first providers of the one or more medical services; extracting second information from the first medical data, the second information regarding the first patient; retrieving third information from the patient-provider index; modifying the third information using the first information and the second information; and storing the third information in the patient-provider index.

In addition, various embodiments can disclose an apparatus configured to access medical data from two or more medical data sources and display the medical data to a first requestor. The medical data can include information regarding at least one of a bone, an organ, or a body tissue. The apparatus can include: (a) a patient-provider index configured to store information about one or more patients, one or more medical providers, and one or more relationships between the one or more patients and the one or more medical providers; (b) an access control module configured to receive a first request for the medical data from the first requestor and further configured to transform the medical data into a visual depiction and transmit the visual depiction of the medical data to the first requestor if the first requestor is granted access to the medical data; (c) a rules index configured to store one or more rules governing access to the medical data; (d) a rules engine module configured define the one or more rules governing access to the medical data and further configured to determining whether to grant access to the medical data to the first requestor at least partially based on the one or more rules and the information stored in the patient-provider index; (e) a patient-provider correlation engine configured to determine the one or more relationships between the one or more patients and the one or more medical providers; and (f) a data retrieval module configured to retrieve the medical data from the two or more medical data sources.

The same or different embodiments also disclose a computer-readable medium that stores instructions executable by at least one processor. The computer-readable medium can include:

(a) instructions for receiving a first request for the medical data from a first requestor, the medical data comprises information regarding at least one of a bone of one or more first patients, an organ of the one or more first patients, or a body tissue of the one or more first patients; (b) instructions for transforming the medical data into a visual depiction; (c) instructions for transmitting the visual depiction of the medical data to the first requestor if the first requestor is granted access to the medical data; (d) instructions for defining one or more rules governing access to the medical data; (e) instructions for storing the one or more rules governing access to the medical data; (f) instructions for determining one or more relationships between the one or more first patients and one or more medical providers; (g) instructions for determining whether to grant the access to the medical data to the first requestor at least partially based on the one or more rules and the one or more relationships between the one or more first patients and the one or more medical providers; and (h) instructions for retrieving the medical data from two or more medical data sources.

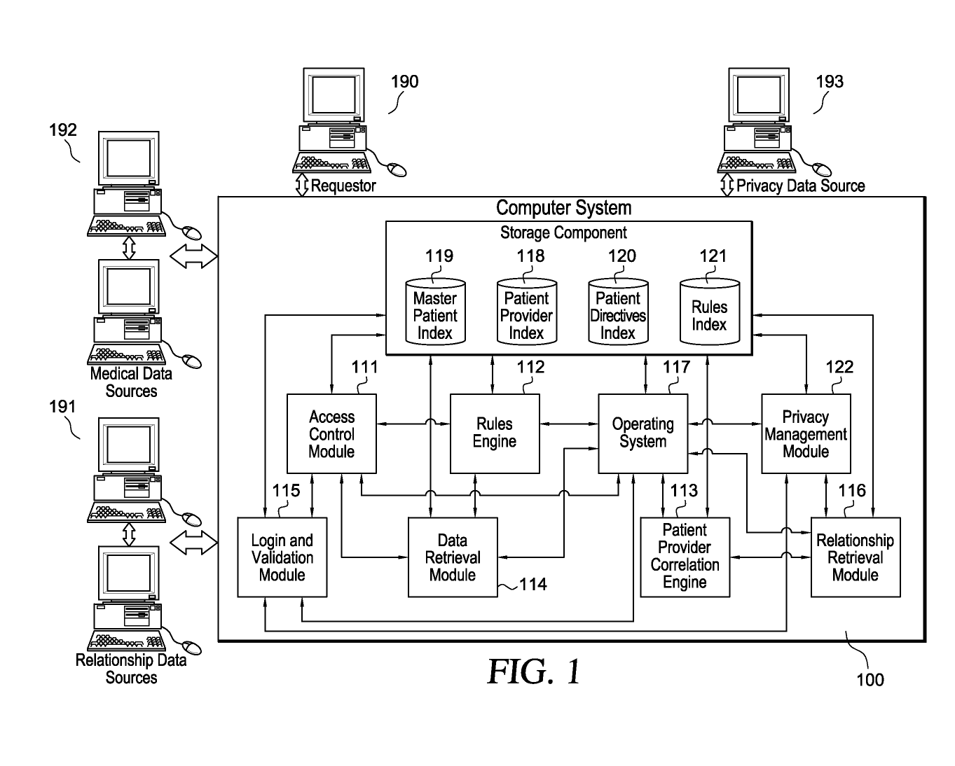

Turning to the drawings, FIG. 1 illustrates a block diagram of a computer system 100 configured to access medical data from two or more medical data sources 192 and display the medical data to a requestor 190, according to a first embodiment. Computer system 100 can also be configured to determine if the requestor of the medical data is authorized to access the data. Computer system 100 is exemplary and is not limited to the embodiments presented herein. Computer system 100 can be employed in different embodiments or examples not depicted or described herein.

Computer system 100 can provide a federated, high-level access control mechanism for medical data that is independent of the underlying system in which the medical data is stored. Computer system 100 can allow an authorized requestor access medical data of a patient from multiple data sources through a single computer system after computer system 100 automatically determines that the requestor is authorized to access the medical data of the patient.

Not to be taken in a limiting sense, a simple example of the usage of computer system 100 begins with a requestor 190 requesting medical data of a patient from computer system 100. For example, a nurse might request X-rays of the patient taken three years ago at another hospital. The X-rays are stored in the other hospital's computer system. In this example, computer system 100 can retrieve the X-rays from the other hospital's computer system. Before providing the X-rays to requestor 190, however, computer system 100 verifies the nurse's identity and determines if the nurse is allowed to access to the X-rays based on a set of access rules and patient directives. If computer system 100 determines the nurse is authorized to access the X-rays, the X-rays are retrieved from the other hospital and displayed to the nurse.

In this example, authorization for the nurse to access the X-rays can be automatically determined by computer system 100 using several different factors. In some embodiments, granting access to the nurse can be determined based upon the nurse's identity, the nurse's role, and the nurse's relationship with the patient, the patient's location, and any patient directives. For example, if the nurse works in the intensive care unit and if the patient was just admitted to the intensive care unit, computer system 100 can conclude based on these factors and the access rules that the nurse is authorized to access the patient's X-rays, even though the nurse has no previous relationship or contact with this patient. Accordingly, computer system 100 provides security to medical data while also allowing quick and easy access to the medical data by authorized medical providers. Without computer system 100, the medical data might otherwise be inaccessible to the medical providers.

Turning to FIG. 1, an example of computer system 100 can include: (a) storage component 110; (b) an access control module 111; (c) a rules engine 112; (d) a patient-provider correlation engine 113; (e) a data retrieval module 114; (f) a login and validation module 115; (g) a relationship retrieval module 116; (h) an operating system 117; and (i) a privacy management module 122

“Computer system 100,” as used herein, can refer to a single computer, single server, or a cluster or collection of servers. Typically, a cluster or collection of servers can be used when the demands by client computers (e.g., requestor 190, relationship data sources 191, and/or medical data sources 192) are beyond the reasonable capability of a single server or computer. In many embodiments, the servers in the cluster or collection of servers are interchangeable from the perspective of the client computers.

In some examples, a single server can include storage component 110, access control module 111, rules engine 112, patient-provider correlation engine 113, data retrieval module 114, login and validation module 115, relationship retrieval module 116, operating system 117, and privacy management module 122. In other examples, a first server can include a first portion of these modules, and one or more second servers can include a second, possibly overlapping, portion of these modules. In these examples, computer system 100 can comprise the combination of the first server and the one or more second servers.

Also, as used herein, depending on the context, a requestor (e.g., requestor 190) can be the medical provider requesting the medical data or the computer system used by the medical provider to request the medical data. That is, depending on the context, the requestor can either be a person or the computer used by the person to make the request for the medical data.

In some examples, storage component 110 can include: (a) a patient-provider index 118; (b) master patient index 119; (c) patient directives index 120; and (d) rules index 121.

All of these indexes (i.e., patient-provider index 118, master patient index 119, patient directives index 120, and rules index 121) can be a structured collection of records or data, which, for instance, is stored in storage component 110. For example, the indexes stored in storage component 110 can be an XML (Extensible Markup Language) database, MySQL, or an Oracle® database. In the same or different embodiments, the indexes could consist of a searchable group of individual data files stored in storage component 110.

Patient-provider index 118 can be configured to store information about one or more patients, one or more medical providers, and the relationships between the one or more patients and the one or more medical providers. In some embodiments, patient-provider index 118 can store patient information, user information, encounter or visit information, financial information, and other types of information.

Patient-provider index 118 can also stored data regarding the relationship of patients to providers (e.g., the medical provider is the admitting physician, the primary care physician, or a consulting physician), data regarding the medical provider's roles (e.g., the medical provider is a physician, surgeon, nurse, or patient advocate in a certain department at a certain hospital), and the organizations to which the provider belongs (e.g., hospitals at which a doctor has privileges, the name of the medical group(s) where the doctor is a member).

For example, patient-provider index 118 can include: (a) identity information (e.g., patient identification (ID), provider ID, aliases, “very important person” (VIP) status, payer information); (b) role information (e.g., caregiver role, organization role, administrative role); (c) relationship information (e.g., HL7 role, familial role, payer role, provider role, memberships, status); and (d) location (e.g., organization, unit, department).

Master patient index 119 can store a unique identifier for every patient treated by a single medical facility or a group of medical facilities. Using a master patient index with a single unique identifier for each patient allows medical facilities to perform easier patient searches, to consolidate duplicate patient records, and share data between computer systems. In some examples, a chain or group of medical facilities or several medical facilities in a geographic area can share a master patient index. In the same or different examples, computer system 100, requestor 190, relationship data sources 191, medical data sources 192, and privacy data source 193 can all use master patient index 119. In some embodiments, master patient index 119 can be an enterprise master patient index (EMPI).

In some examples, master patient index 119 can include the following information about each patient: (a) a unique identification number; (b) the name or an identifier for the primary medical facility where the patient receives medical services; (c) legal name of the patient; (d) the date of birth of the patient; (e) the patient's gender; (f) the patient's race; (g) the patient's ethnicity; (h) the address and phone number for the patient; (i) any alias and/or the maiden name of the patient; and (j) the social security number of the patient.

In some embodiments, patient directives index 120 can store information about patient directives or instructions. For example, patient directives index 120 can store information noting that a specific patient has authorized sharing of only his medical data related to physical conditions and has not authorized sharing of his medical data related to any psychological conditions.

In some embodiments, rules index 121 can store information about access rules. In some examples, access rules are the general or default rules to gain access using a computer system to the medical data for all patients. Patient directives, on the other hand, are special limitations on accessing the medical data applicable to only a single patient or a small group of patients. The access rules can control whether a person is allowed to access medical data for a patient based on the identity of the patient, the medical provider's role, the medical provider's relationship with the patient, and the location. The access rules can also require the medical provider to perform one or more steps (e.g., break the glass) before being granted access to the medical data for a specific patient. Breaking the glass (BTG) means that the requestor needs to provide a reason why she is accessing the medical data before being granted access.

Relationship retrieval module 116 can be configured to access the information about one or more patients and one or more medical providers used to create patient-provider index 118. That is, relationship retrieval module 116 can gather the information used to determine the relationships stored in patient-provider index 118. In some examples, relationship retrieval module 116 can gather the information from relationship data sources 191.

In some examples, relationship retrieval module 116 can procure information from relationship data sources 191 using several methods. In some embodiments, the information can be at least partially entered directly into computer system 100. For example if a non-automated medical facility wanted to enter its patient lists into computer system 100, the medical facility could have the patient list and related information manually inputted into computer system 100 using relationship retrieval module 116.

Another method that can be used by relationship retrieval module 116 to obtain the information used to populate patient-provider index 118 is to infer the information from communications or transactions between other systems. For example, relationship retrieval module 116 can intercept or receive transactions between relationship data sources 191 (e.g., a message between the pathology department's computer system and the emergency room's computer system regarding a patient).

HL7 includes a protocol for transactions (i.e., messages) between different computer systems. Accordingly, in embodiments where the computer systems are using the HL7 protocol, relationship retrieval module 116 can intercept and decode transactions between relationship data sources 191 that potentially contain information useful in creating or otherwise modifying patient-provider index 118. For example, a transaction between the pathology department and the emergency room's computer system might contain information about who is the treating or consulting physician for a specific patient.

In the same or different embodiment, the HL7 Protocol includes a mechanism where a computer system can be sent copies of all or certain type of transactions between other computer systems. Accordingly, relationship data sources 191 and computer system 100 can be configured such that copies of all or specific types of transactions are sent to computer system 100. For example, the pathology department computer system can be configured such that copies of all transactions from the pathology department computers are carbon-copied to computer system 100.

Patient-provider correlation engine 113 can be configured to determine the relationships between the one or more patients and the one or more medical providers. After patient-provider correlation engine 113 determines the relationships, patient-provider correlation engine 113 stores this information in patient-provider index 118.

In some examples, patient-provider correlation engine 113 can receive transactions from relationship retrieval module 116 and parse the data in the transactions to extract any useful information. For example, a message sent by the pathology department's computer system could have information about tests ordered for a patient and which doctor performed the tests. Using this information, patient-provider correlation engine 113 could determine a relationship exists between the doctor performing the test and the patient. In another example, a transaction could include the information that a certain patient is being treated at a certain medical facility. From this information, patient-provider correlation engine 113 could determine that a relationship exists between the patient and the medical providers associated with this certain medical facility.

Login and validation module 115 can be configured to receive login information and validate an identity of the requestor. In some examples, the user of computer system 100 can login using a username and password. Login and validation module 115 can validate the username and password combination. In some examples, a person making the request does not login into computer system 100 directly but rather logs into a separate computer system (i.e., requestor 190) that is not part of computer system 100. In one embodiment, the separate computer system can authenticate the username and password and communicate to computer system 100 that the user has been properly authenticated.

In various embodiments, if requestor 190 and computer system 100 are not part of the same computer or system (e.g., both computer systems are not located in the same medical facility), the owners of the different computer systems can enter into formal contracts that establish trust between the different computer systems. For example, a hospital and a doctor's office can enter an agreement where the hospital's computer system would recognized a user as properly authenticated if the user is authenticated by the doctors office's computer system. Similarly, under the agreement, the doctor's office's computer system can recognize a user as properly authenticated if the user is authenticated by the hospital's computer system.

Access control module 111 can be configured to receive requests for the medical data and can be further configured to transform the medical data into a visual depiction if access is granted access to the medical data.

Rules engine 112 can be configured to define the rules governing access to the medical data and also can be configured to determine whether to grant access to the medical data based on the information stored in storage component 110. In some examples, rules engine 112 can receive the request to access the medical data from access control module 111 and determine whether to authorize access based on the access rules (in rules index 121), the patient directives (in patient directives index 120), and the information stored in patient-provider index 118.

Data retrieval module 114 can be configured to retrieve medical data from the two or more medical data sources 192. For example, if rules engine 112 determines that requestor 190 is allowed to access the medical data, data retrieval module 114 can retrieve the medical data from medical data sources 192 and communicate the medical data to access control module 111. In other examples, data retrieval module 114 can begin retrieving the medical data before access is granted to minimize the delay in providing the medical data to requestor 190.

Privacy management module 122 can be configured to allow one or more users to set the access rules and input the patient directives. In some examples, privacy management module 122 can provide a mechanism where a privacy director or other personnel at a medical facility can input one or more access rules for the medical data through computer system 100. Privacy management module 122 can upload the access rules to rules index 121. Similarly, privacy management module 122 can receive the patient directives regarding access to the patient's medical data and upload the information to patient directives index 120. Furthermore, privacy management module 122 can receive consent information from external sources (e.g., medical facilities not associated with computer system 100) and provide consent information to external sources. In some examples, the consent information can be received and provide in standardized formats.

In various embodiments, operating system 117 can be a software program that manages the hardware and software resources of a computer and/or a computer network. Operating system 117 performs basic tasks such as, for example, controlling and allocating memory, prioritizing the processing of instructions, controlling input and output devices, facilitating networking, and managing files. Examples of common operating systems (OS) include Microsoft® Windows® OS, Mac® OS, UNIX® OS, and Linux® OS.

In some examples, a single computer system can be requestor 190, one of relationship data sources 191, one of medical data sources 192, and privacy data source 193. That is, one computer system can play each of these separate roles in different situations. Even though one computer system can play each of these roles, FIG. 1 shows each of these systems as separate elements for the sake of clarity. For example, the pathology department's computer system can be requestor 190, one of relationship data sources 191, one of medical data sources 192, and privacy data source 193 in different situations. The pathology department computer system can be the source of patient-provider information; it could store medical data that may be requested by other computer systems; and a user of the pathology department computer system could be a requestor of medical data from other computer systems.

In the same or different examples, one or more computer systems can only fulfill only one or two of the roles of requestor 190, relationship data sources 191, medical data sources 192, and privacy data source 193. For example, a certain computer system might not store any medical data, so this computer system could serve only as requestor 190 or relationship data sources 191. Also, some computer systems could be limited to one or more of these roles for security reasons.

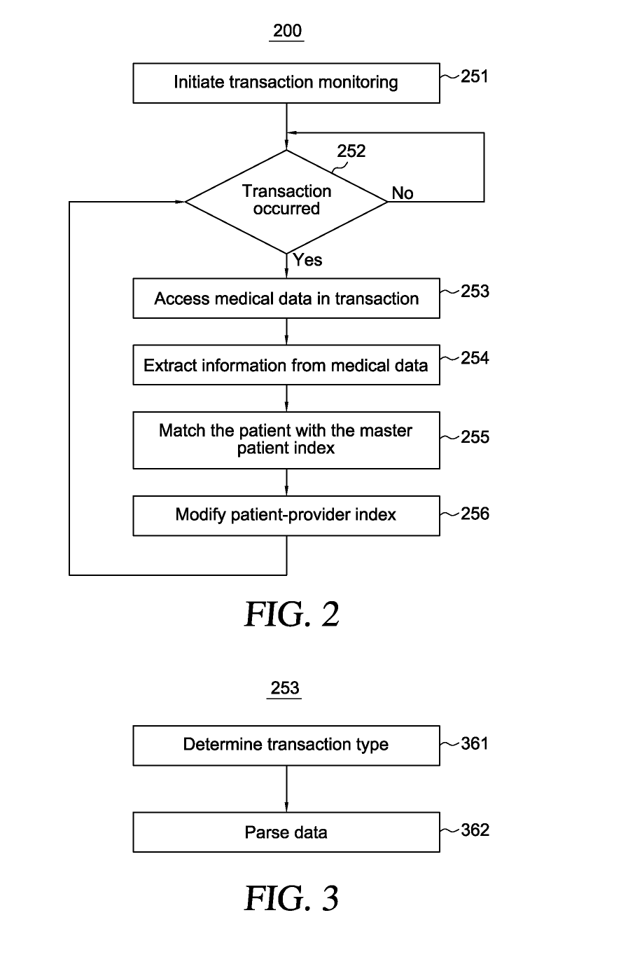

FIG. 2 illustrates a flow chart for an embodiment of a method 200 of providing a patient-provider index, according to the first embodiment. Method 200 can also be considered a method of building a patient-provider index. Method 200 is merely exemplary and is not limited to the embodiments presented herein. Method 200 can be employed in many different embodiments or examples not specifically depicted or described herein. The patient-provider index provided using method 200 can be used to determine whether to authorize access to medical data by a requestor.

Method 200 in FIG. 2 can include an activity 251 of initiating transaction monitoring. In some examples, computer system 100 (FIG. 1) can initiate relationship retrieval module 116 (FIG. 1) to monitor transactions between relationship data sources 191 (FIG. 1).

Method 200 in FIG. 2 continues with an activity 252 of determining if a transaction has occurred. A transaction occurs when one of relationship data sources 191 (FIG. 1) transmits information about a patient or a medical provider. For example, when a patient is admitted to a hospital, the ADT (admission, discharge, and transfer) system can send a message to other relationship data sources 191 (FIG. 1) notifying the other systems of the admission of the patient and providing information about the admitted patient. In some examples, relationship retrieval module 116 (FIG. 1) can monitor for transactions. In some embodiments, relationship retrieval module 116 (FIG. 1) can monitor for transactions between relationship data sources 191 (FIG. 1). In the same or different embodiments, relationship retrieval module 116 (FIG. 1) can receive copies of transactions from the sender and/or receiver of the message. In still further embodiments, relationship retrieval module 116 (FIG. 1) can periodically access relationship data sources 191 (FIG. 1) to check for any new transactions.

When a transaction has occurred, the next activity in method 200 is an activity 253 of accessing the medical data in the transaction. FIG. 3 illustrates an example of accessing the medical data in the transaction, according to the first embodiment. In some embodiments, the medical data can be information regarding one or more medical services provided to the first patient. For example, the medical data can include at least one of X-ray data and cardiac signal data.

Turning to FIG. 3, a first process 361 in activity 253 is determining the transaction type. For HL7 transactions, there can be four primary types of messages defined by the HL7 protocols from which useful information can be extracted: (a) ADT messages used to convey information about a patient or a healthcare encounters; (b) order (ORD) messages regarding request for materials (e.g., 500 milliliters (mL) of 2.5 percent (%) saline solution) or services (e.g., an EKG (electrocardiogram)) for a patient; (c) observation result (ORU) messages to provide clinical data (e.g., EKG results) about a patient; and (d) detailed financial transaction (DFT) messages to provide financial information. Patient-provider correlation engine 113 (FIG. 1) can receive the transaction from relationship retrieval module 116 (FIG. 1) and determine the transaction type.

The next process 362 in activity 253 of FIG. 3 is a process of parsing the information from the medical data. In some examples, relationship retrieval module 116 (FIG. 1) can parse the information in the medical data into an ordered result. In some embodiments, the messaging protocol (e.g., the HL7 protocol) can allow for relatively free-form messages between relationship data sources 191 (FIG. 1). In these embodiments, relationship retrieval module 116 (FIG. 1) can parse the data in the message to determine the fields and data contained in the transaction. After parsing the medical data, activity 253 of FIG. 3 is complete.

Referring again to FIG. 2, the next procedure in method 200 of FIG. 2 is an activity 254 of extracting information from the medical data. In some examples, relationship retrieval module 116 (FIG. 1) can extract information from the medical data. In many embodiments, identity information, role information, relationship information, and location information for any patients or medical providers mentioned in the transition can be extracted. For example, a transaction can include cardiac test results for a patient Avery Smith for tests performed at the XYZ hospital by a cardiologist Jennifer Doe. From this medical data, relationship retrieval module 116 (FIG. 1) could extract: (a) identity information (e.g., the patient ID for Avery Smith and the provider ID for Jennifer Doe); (b) role information (e.g., Jennifer Doe is a cardiologist); (c) relationship info (e.g., Jennifer Doe is a consulting physician for Avery Smith); and (d) locational information (e.g., Avery Smith is a patient at XYZ hospital and is/was being treated in the cardiology department; Jennifer Doe has physician privileges at XYZ hospital).

In additional as part of activity 254, the information extracted from the medical data can be normalized. That is, different relationship data sources 191 (FIG. 1), medical facilities, and/or medical providers can use different or non-standard names or descriptions. Relationship retrieval module 116 (FIG. 1) can normalize the names and descriptions to a predetermined standard set of names and descriptions. For example, the transaction discussed above could refer to Jennifer Doe as the “treating cardiologist.” Relationship retrieval module 116 (FIG. 1) can determine that the terminology in this transaction was non-standard and change the description of Jennifer Doe from “treating cardiologist” to “consulting physician” to be consistent with the terminology used in patient-provider index 118 (FIG. 1).

Method 200 in FIG. 2 continues with an activity 255 of matching the patient with the master patient index. In this activity, the identity information extracted from the medical data in activity 254 is compared with the records in the master patient index to determine the correct master patient ID. In many cases, a medical facility can identify the patient by an alias and/or a facility specific ID number. In some examples, relationship data sources 191 (FIG. 1) can use only non-alias or master patient IDs to identify the patients. In these examples, relationship retrieval module 116 (FIG. 1) can access master patient index 119 (FIG. 1) to determine the correct master patient ID. If a master patient index does not exist, activity 255 can be omitted.

Next, method 200 of FIG. 2 includes an activity 256 of modifying the patient-provider index. In some examples, the normalized data extracted from the medical data in activity 254 can be stored into patient-provider index 118 (FIG. 1). That is, relationship retrieval module 116 (FIG. 1) can store in patient-provider index 118 the identity information, role information, relationship information, and location information. After activity 256, the next activity is activity 252 of determining whether a transaction has occurred.

In the same of different example, modifying the patient-provider index can include retrieving information from the patient-provider index and modifying the retrieved information with the normalized data extract from the medical data in activity 254. For example, relationship retrieval module 116 (FIG. 1) can retrieve the information in the patient-provider index regarding identity information, role information, relationship information, and location information for any patients or medical providers mentioned in the transition in activity 253. This information can be modified to reflect the new normalized data extracted from the medical data in activity 254. For example, if Jennifer Doe is listed as a treating physician for Avery Smith, the information can be modified so Jennifer Doe is now a consulting physician for Avery Smith. After the information is modified, it can be storing in the patient-provider index.

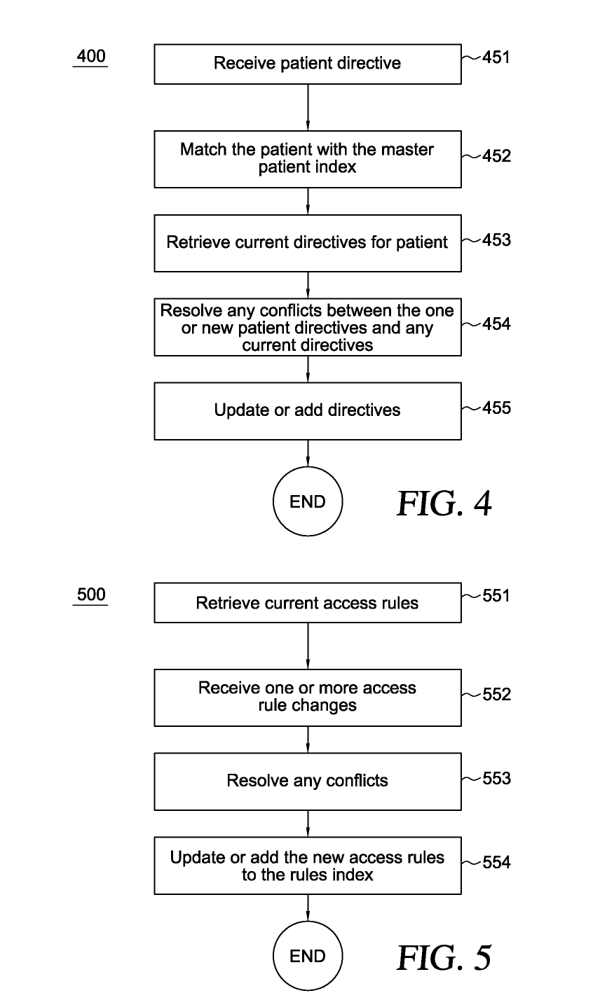

FIG. 4 illustrates a flow chart for an embodiment of a method 400 of providing, building, or modifying a patient directive index, according to the first embodiment. Method 400 is merely exemplary and is not limited to the embodiments presented herein. Method 400 can be employed in many different embodiments or examples not specifically depicted or described herein. The patient directive index can be used in determining whether to authorize access to medical data by a requestor.

Method 400 in FIG. 4 first includes an activity 451 of receiving one or more patient directives. Patient directives can be provided by one or more consent management tools used by medical facilities that give a patient control of who has access to his medical and financial information. Using a patient directive, a patient can opt-out or limit who has access to his medical or financial information.

In some examples, privacy management module 122 (FIG. 1) can receive the one or more patient directives from privacy data source 193 (FIG. 1). In some examples, the one or more patient directives are entered directly into computer system 100 (FIG. 1) by the patient or a privacy officer at a medical facility. In other examples, the one or more directives are part of information gathered by privacy data source 193 (e.g., the ADT computer system) and transmitted to computer system 100 (FIG. 1).

In some examples, privacy data source 193 (FIG. 1) can be a privacy officer at the medical facility, the patient, or family members of the patient (or a computer used by the privacy officer, the patient, or the family members). In the same or different embodiment, privacy data source 193 (FIG. 1) can be other computer systems at medical facilities that are coupled to computer system 100. For example, privacy data source 193 could be the ADT computer system for the medical facility. In this example, as part of the admittance of a new patient, the admittance form signed by the patient can include default patient directives, or the admittance forms could require the patient to answer several question regarding access to his or her medical and financial information. After gathering the directive information from the patient, the ADT system could send the information to privacy management module 122 (FIG. 1). In addition to consent information entered into computer system 100, privacy management module 122 can receive consent information (e.g., a consent rule in an Integrating Healthcare Enterprise (IHE) compliant format) from privacy data source 193 (e.g., an external healthcare facility). Privacy management module 122 can convert or modify the consent information from the external source so the consent information can be used by computer system 100.

Method 400 in FIG. 4 continues with an activity 452 of matching the patient with the master patient index. In some embodiments, the patient for which the one or more patient directives were received is matched with a patient name and master patient ID in the master patient index. That is, patient information received in activity 451 is compared with the records in the master patient index to determine the correct master patient ID. In some examples, the master patient ID is not received in activity 451, or the patient is identified by an alias in activity 451, so the master patient ID needs to be determined. Thus, privacy management module 122 (FIG. 1) can access master patient index 119 (FIG. 1) to determine the correct master patient ID. If a master patient index does not exist, activity 452 can be omitted.

Next, method 400 in FIG. 4 includes an activity 453 of retrieving the current directives for the patient. In some examples, privacy management module 122 (FIG. 1) can retrieve any current directives for the patient from patient directives index 120 (FIG. 1). If no directives exist for the patient, activity 454 can be skipped.

Subsequently, method 400 in FIG. 4 continues with an activity 454 of resolving any conflicts between the one or more new patient directives and any current or existing directives. In some examples, privacy management module 122 (FIG. 1) can compare the one or more new patient directives with the existing directives to determined if any conflicts exist. For example, an existing directive could state that the patient grants access to all medical records to any doctor. The new directive, however, could limit access to his psychological records. Privacy management module 122 (FIG. 1) can flag this conflict for resolution.

In some examples, privacy management module 122 (FIG. 1) can also automatically resolve the conflict based on one or more default rules. For example, if two patient directives are conflicting, the more recent of the two directives could override the earlier directive. In different examples, the more restrictive of the two patient directives can be controlling.

In other examples, privacy management module 122 (FIG. 1) can present the conflict to either the patient or a privacy officer for resolution. For example, if the patient is directly entering the directives into computer system 100 (FIG. 1), the conflict can be presented to the patient, and the patient can be asked to confirm or clarify his or her directive. In still further examples, privacy management module 122 (FIG. 1) can present the conflicts to a privacy officer at medical facility for resolution. If no existing directives exist for the patient, activity 455 can be skipped.

After any conflicts have been resolved, the next activity in method 400 of FIG. 4 is an activity 455 of updating or adding directives to the patient directive index. In some examples, privacy management module 122 (FIG. 1) can update or add the new directives to patient directives index 120 (FIG. 1). After activity 455, method 400 is complete.

FIG. 5 illustrates a flow chart for an embodiment of a method 500 of providing, building, or modifying one or more access rules, according to the first embodiment. Method 500 is merely exemplary and is not limited to the embodiments presented herein. Method 500 can be employed in many different embodiments or examples not specifically depicted or described herein. The one or more access rules can be used in determining whether to authorize access to the medical data by the requestor.

Method 500 in FIG. 5 includes an activity 551 of retrieving current access rules. In some examples, rules engine 112 (FIG. 1) can retrieve the current access rules from rules index 121 (FIG. 1).

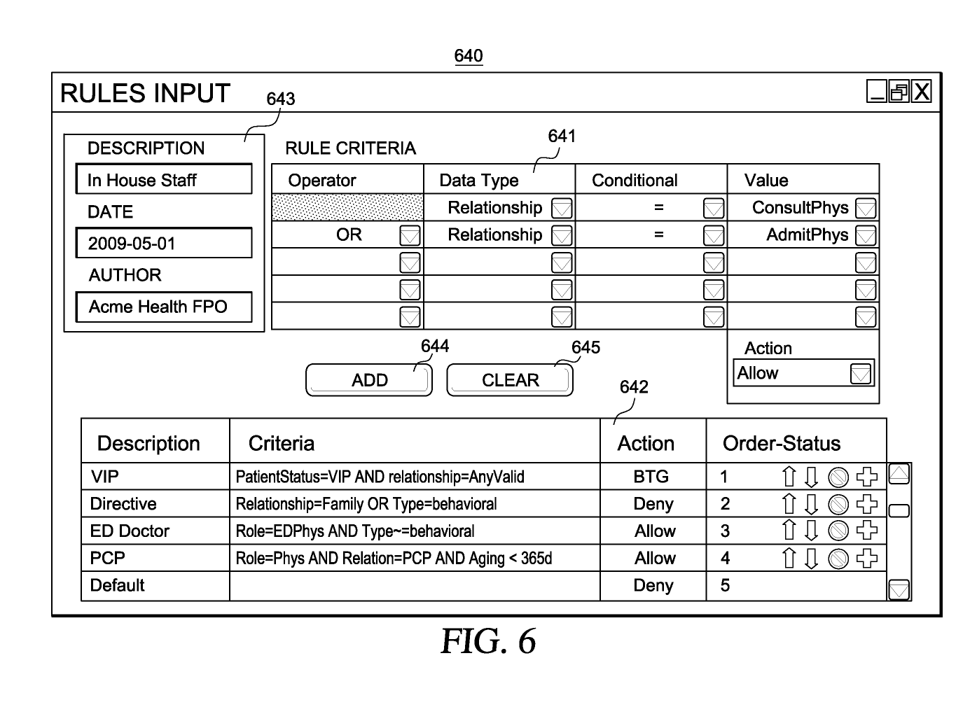

Method 500 in FIG. 5 continues with an activity 552 of receiving one or more access rule changes. In some examples, computer system 100 can display a window for a privacy data source 193 (e.g., a privacy officer or another person designated by a medical facility) to input the access rules for granting access to medical data using computer system 100 (FIG. 1). FIG. 6 illustrates an example of a rules input window 640, according to the first embodiment.

Referring to FIG. 6, rules input window 640 include: (a) a descriptive information segment 643; (b) new rule criteria input 641; (c) current rules description region 642; and (d) buttons 644 and 645. Descriptive information segment 643 can show general information such as the user's (i.e., author's) name, the date, and a description of the user. Current rules description region 642 provides a list of the current access rules. For example, the first rule listed in current rules description region 642 is: if a patient's status is VIP, regardless of the medical provider's relationship with the patient, breaking the glass (BTG) is required to access the medical data for the patient.

New rule criteria input 641 provides a region where the user can input new rules. For example, a rule can be entered where if the medical provider's relationship with the patient is the consulting physician or admitting physician, the requestor is allowed access to the medical data.

As part of activity 551 (FIG. 5), one or more new rules can be entered into computer system 100 using rules input window 640. In some examples, the new rules can be entered into new rule criteria input 641, and button 644 can be pushed to submit the new rule(s).

Referring again to FIG. 5, after receiving one or more new access rules, method 500 in FIG. 5 continues with an activity 553 of resolving conflicts between the one or more new access rules and any current access rules. In some examples, rules engine 112 (FIG. 1) can compare the one or new access rules with the existing access rules to determined if any conflicts exist. For example, the existing access rules could grant access to all medical records to any doctor. However, the new access rules could limit access to patient's psychological records to only primary care physicians, psychologists, and psychiatrists. Rules engine 112 (FIG. 1) can flag this conflict for resolution.

In some examples, rules engine 112 (FIG. 1) could automatically resolve the conflict based on some default rules. For example, if two access rules are conflicting, the most recent of the two access rule could override the earlier access rule. In other examples, rules engine 112 (FIG. 1) can present the conflict to the privacy data source 193 (FIG. 1) for resolution. For example, if the privacy manager is directly entering the access rules into computer system 100 (FIG. 1), the conflict can be presented to the privacy officer, and the privacy officer can be asked to confirm or clarify the new access rules.

After the conflict has been resolved, the next activity in method 500 of FIG. 5 is an activity 554 of updating or adding the new access rules to the rules index. In some examples, rules engine 112 (FIG. 1) can update or add the new access rules to rules index 121 (FIG. 1). After activity 554, method 500 is complete.

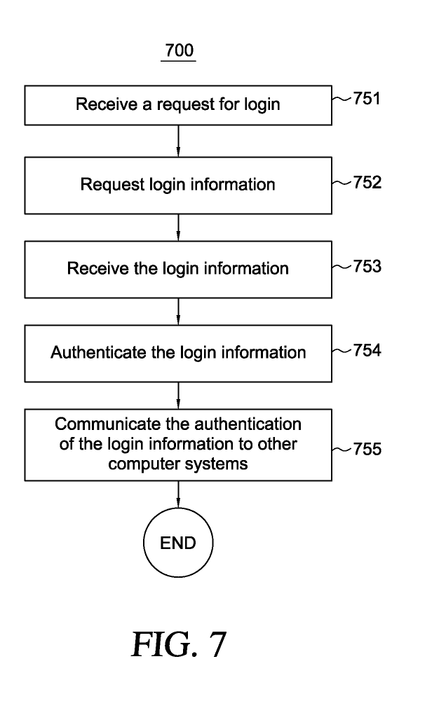

FIG. 7 illustrates a flow chart for an embodiment of a method 700 of receiving login information from a requestor and validating an identity of the requestor. Method 700 is merely exemplary and is not limited to the embodiments presented herein. Method 700 can be employed in many different embodiments or examples not specifically depicted or described herein.

Turning to FIG. 7, method 700 can include a first activity 751 of receiving a request for login. In some examples, a user (e.g., a medical provider or a privacy officer) can attempt to login to requestor 190 (FIG. 1), privacy data source 193 (FIG. 1), or other computer systems. In other examples, the user can request to login to computer system 100.

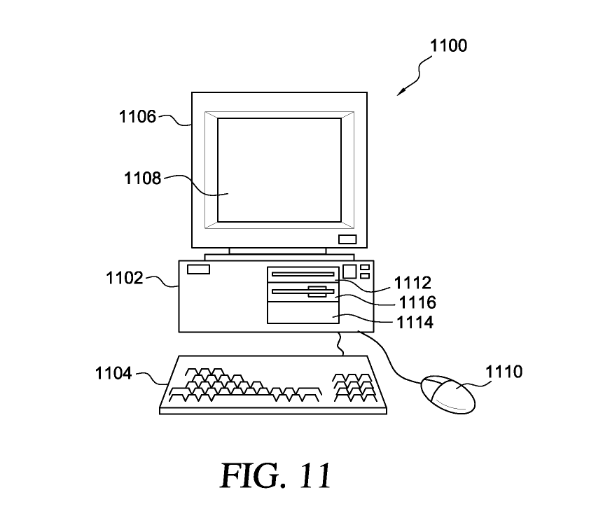

Method 700 in FIG. 7 can include an activity 752 of requesting login information. The computer system can request login information (e.g., a username and password) from the user. For example, requestor 190 (FIG. 1), privacy data source 193 (FIG. 1), or computer system 100 (FIG. 1) can request the login information from the user by providing a window on a monitor 1106 (FIG. 11) where the user can enter the login information.

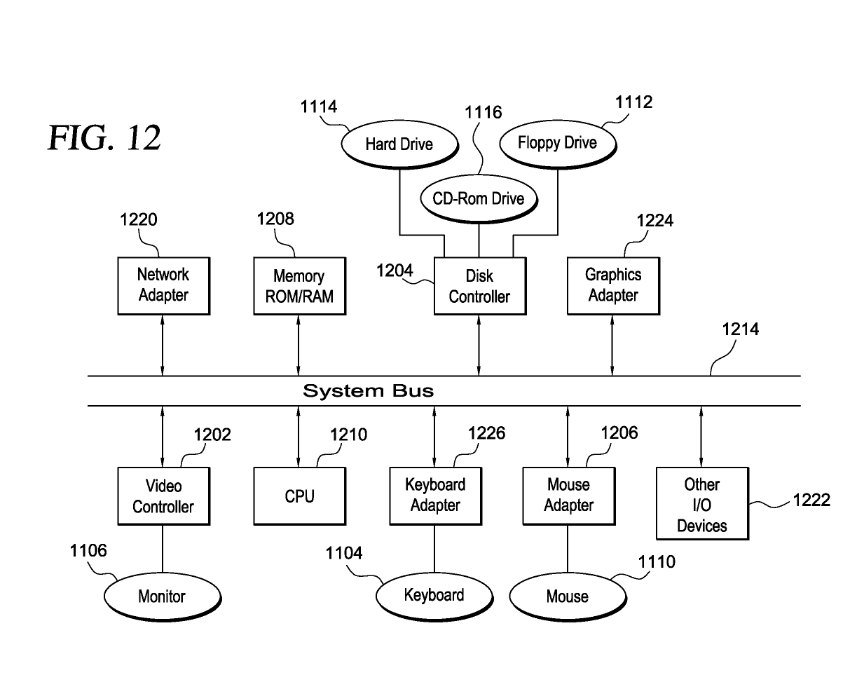

Subsequently, method 700 in FIG. 7 can include an activity 753 of receiving login information. In some examples, the user can enter the information in a window on monitor 1106 (FIGS. 11 and 12) and click submit using mouse 1110 (FIGS. 11 and 12).

The next activity in method 700 of FIG. 7 is an activity 754 of authenticating the login information. In some examples, requestor 190 (FIG. 1), privacy data source 193 (FIG. 1), or computer system 100 (FIG. 1) can compare the login information with the login information stored for that user. If the login information matches the user is authenticated.

Afterwards, method 700 of FIG. 7 can include an activity 755 of communicating the authentication of the login information to other computer systems. For examples, requestor 190 (FIG. 1) or privacy data source 193 (FIG. 1) can communicate that the user's login was authenticated to computer system 100 (FIG. 1). After activity 755, method 700 is complete.

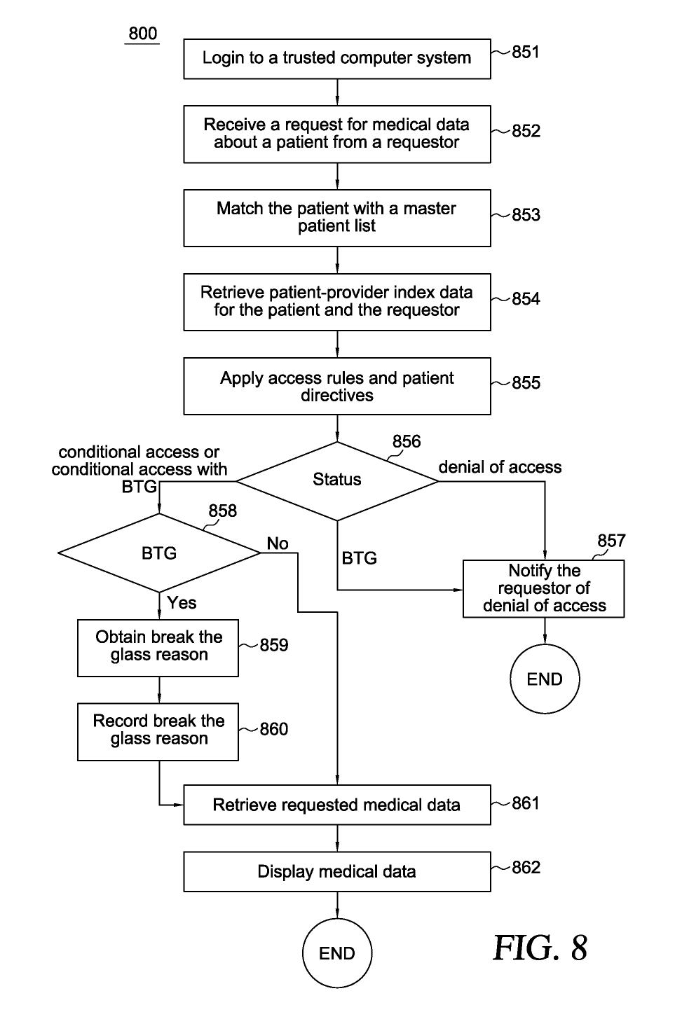

FIG. 8 illustrates a flow chart for an embodiment of a method 800 of accessing medical data from two or more data sources, according to the first embodiment. Method 800 can also be considered a method of retrieving and displaying patient information. Method 800 is merely exemplary and is not limited to the embodiments presented herein. Method 800 can be employed in many different embodiments or examples not specifically depicted or described herein.

Method 800 in FIG. 8 can include a first activity 851 of logging into a computer system. In some examples, the requestor can login directly to a trusted computer system (e.g., computer system 100 (FIG. 1), relationship data sources 191 (FIG. 1), or medical data sources 192 (FIG. 1)). The method of logging in and authenticating a user can be accomplished as described above in method 700 in FIG. 7. In other examples, the user is already logged-in into a trusted computer system, and activity 851 is skipped.

Next, method 800 in FIG. 8 can include an activity 852 of receiving a request for medical data about a first patient from the requestor. In some examples, the medical data requested about the first patient can include information regarding at least one of a bone of the first patient, an organ of the first patient, or a body tissue of the first patient. As an example, a body tissue can be an arm or a biopsy from the patient's skin or bicep. In the same or different example, the request for medical data for a first patient can be made by requestor 190 (FIG. 1) to computer system 100 (FIG. 1). In various embodiments, access control module 111 (FIG. 1) can receive the request for the medical data.

The next activity in method 800 in FIG. 8 is an activity 853 of matching the patient with the master patient index. In some embodiments, the patient for which medical information was requested is matched with patient names and master patient IDs in the master patient index. That is, patient information received in activity 852 is compared with the records in the master patient index to determine the correct master patient ID. In some examples, the master patient ID is not received in activity 852, or the patient is identified by an alias in activity 852. In these examples, access control module 111 (FIG. 1) can access master patient index 119 (FIG. 1) to determine the correct master patient ID. If a master patient index does not exist, activity 853 can be omitted.

Method 800 in FIG. 8 continues with an activity 854 of retrieving patient-provider index data for the patient and the requestor. In some examples, rules engine 112 (FIG. 1) can access patient-provider index 118 and retrieve the data in the patient-provider index 118 related to the requestor and the patient. The patient and provider information retrieved in this activity can be used to determine whether the request is authorized to access the medical data of the patient. In some examples, retrieving patient-provider index data for the patient and the requestor can be considered retrieving first access information about the first patient and retrieving second access information about the first requestor.

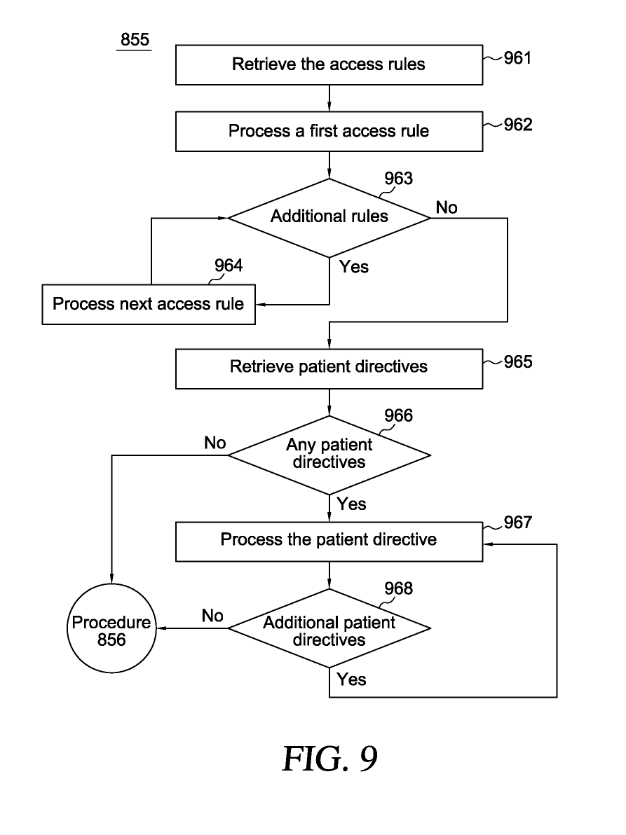

Subsequently, method 800 in FIG. 8 includes an activity 855 of applying the access rules and patient directives. In some examples, rules engine 112 can apply the access rules and patient directives to this request for access to the medical data of the first patient. FIG. 9 illustrates a flow chart for an embodiment of activity 855 of applying the access rules and patient directives, according to the first embodiment.

Turning to FIG. 9, the first activity in activity 855 is a procedure 961 of retrieving the access rules. In some examples, rules engine 112 (FIG. 1) can retrieve the access rules from rules index 121 (FIG. 1).

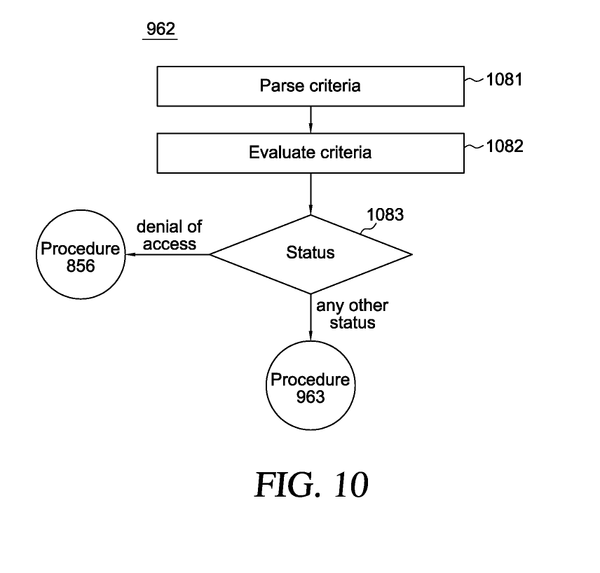

Activity 855 in FIG. 9 continues with a procedure 962 of processing the first access rule. In some examples, rules engine 112 can process the first access rule. If no rules have been entered, one or more default rules can exist, and rules engine 112 (FIG. 1) will process the default rules. FIG. 10 illustrates a flow chart for an embodiment of procedure 962 of processing an access rule, according to the first embodiment.

The first process in procedure 962 of FIG. 10 is a process 1081 of parsing the criteria of access rule. In some examples, rules engine 112 (FIG. 1) parses the criteria of the access rule into two or more separate parts if necessary.

Procedure 962 in FIG. 10 continues with a process 1082 of evaluating the parsed criteria. In some examples, rules engine 112 (FIG. 1) can evaluate the criteria. In some examples, evaluation of an access rule can lead to one of four possible results: (a) conditional access granted status; (b) BTG status; (c) conditional access granted with BTG status; or (d) denial of access.

Conditional access granted status means that the requestor has met the criteria in the access rules to be granted access to the medical data. Accordingly, access to the medical data will be granted assuming the requestor is not denied access by another rule (or patient directive). For example, a first rule might say, if medical provider's relationship with the patient is the consulting physician or the admitting physician, the requestor is allowed access to the medical data. In this case, if the requestor's role is the admitting physician, the requestor's status is changed to conditional access granted status.

On the other hand, a second rule might say to deny everyone access to the patient's psychological medical records. In this case, while evaluation of the first rule would result in a conditional access granted status for the patient's admitting physician, the requestor's status would be changed to a denial of access when the second rule is evaluated if the patient's admitting physician is requesting to view the patient's psychological medical records. Accordingly, the requestor's grant of access is “conditional” until all access rules and patient directives have been evaluated.

BTG status means that the requestor must break the glass before accessing the medical data. For example, a rule can say for a patient with VIP status, any requestor must break-the-glass before accessing the patient's medical data. Evaluation of this example VIP rule by rules engine 112 (FIG. 1) would change the requestor status to BTG status. Conditional access with BTG status mean that the requestor had met the criteria in one or more access rules to be granted access, but must break-the-glass before accessing in the medical data. Denial of access means that the requestor is denied access to the medical data.

In another embodiment, evaluation of an access rule can possible lead to fifth possible result, call status. Call status means that an external process (e.g., a patient acknowledgement or a 3^{rd} party rule) can be used to conditionally grant or deny access to the medical data.

After evaluation of the first access rule, the next process in procedure 962 is a process 1083 of determining the status of the request. If the status of the request is denial of access, procedure 962 and activity 855 are complete, and the next activity is activity 856. If the status is anything except denial of access, procedure 962 is complete, and the next procedure is procedure 963.

Turning again to FIG. 9, activity 855 includes a procedure 963 of determining if any additional access rules exist. If an additional access rule exists, the next procedure in activity 855 is a procedure 964 of processing the next access rule. In some examples, procedure 964 can be similar or identical to procedure 962. In a different embodiment, activity 964 is omitted, and additional access rules are processed by activity 962. After procedure 964 is complete, the next procedure is procedure 963 of determining if any additional access rules exist.

If no additional access rules exist, the next procedure after procedure 963 is a procedure 965 of retrieving any patient directives. In some examples, rules engine 112 (FIG. 1) can retrieve the patient directives for the patient from patient directives index 120 (FIG. 1).

Activity 855 in FIG. 9 continues with a procedure 966 of determining if any patient directives exist. In some examples, rules engine 112 can determine if any patient directives exist. If no patient directives exist, activity 855 is complete, and the next activity is activity 856.

If one or more patient directive exists, the next procedure is a procedure 967 of processing the patient directive. In some examples, rules engine 112 can process the first patient directive. Processing the patient directive in procedure 967 can be similar or identical to procedure 962 of processing the first access rule.

Activity 855 in FIG. 9 continues with a procedure 968 of determining if any additional patient directives exist. In some examples, rules engine 112 (FIG. 1) can determine if any additional patient directives exist. If one or more additional patient directives exist, the next procedure is a procedure 967 of processing the next patient directive. If no additional patient directives exist, activity 855 is complete, and the next activity is activity 856.

Referring again to FIG. 8, after activity 855 is complete, the next activity is activity 856 of determining the status of the request. As discussed above, the request can have one of four statuses: (a) conditional access granted; (b) conditional access grant with BTG; (c) BTG; or (d) denial of access. In many examples, the default status is denial of access. Accordingly, if the status of request was not changed to one of the first three statuses in activity 855, the default status is denial of access.

In many examples, when a determine of the status is completed, an audit trial can be created. That is, rules engine 112 (FIG. 1) can stored the status and the reasons for that status in storage component 110 (FIG. 1). In some examples, the audit trial can be created as part of activity 855. In other examples, the audit trial can be created by different modules in different activities. For example, data retrieval module 114 (FIG. 1) could create the audit trial (or an additional audit trail) before retrieving the requested medical information in activity 861 (FIG. 8).

If the status is denial of access or BTG, the next activity in method 800 is an activity 857 of notifying the requestor of the denial of services. In some examples, access control module 111 can inform the requestor of the denial of access. In various embodiments, access control module 111 can also provide a reason why access was denied.

Access is denied in activity 857 to a request with BTG status because all of the access rules and patient directives have been evaluated and because none of the access rules or patient directives granted access to the requestor.

If the status is a conditional access or conditional access with BTG, the next activity in method 800 is an activity 858 of determining if BTG is required. If BTG is not required, the next activity is an activity 861.

If the status requires BTG, the next activity in method 800 is an activity 859 of obtaining the breaking-the-glass reason. In some examples, access control module 111 (FIG. 1) can obtain from the requestor the reason that the requestor is seeking access to the medical data.

Subsequently, method 800 includes an activity 860 of recording the breaking-the-glass reason. In some examples, access control module 111 (FIG. 1) can store the breaking-the-glass reason in a log file in storage component 110 (FIG. 1).

Method 800 continues with an activity 861 of retrieving the requested medical data. In some examples, data retrieval module 114 (FIG. 1) can send a request for the medical data to one of medical data sources 192 (FIG. 1), and the medical data source can return the medical data to data retrieval module 114 (FIG. 1).

In other embodiments, data retrieval module 114 (FIG. 1) can execute one or more workflows (e.g., a series of instructions) to manipulate or use one of medical data sources 192 (FIG. 1) to access the medical data. For example, data retrieval module 114 (FIG. 1) can perform a workflow on one of medical data sources 192 (FIG. 1) that changes the context (e.g., changes the patient) and downloads the medical data from the medical data source. U.S. Patent Application Publication No. 2008/0172669 to McCullough, et al., filed Jan. 12, 2007, provides an example of a system and method for executing one or more workflows on a medical data source. U.S. Patent Application Publication No. 2008/0172669 is incorporated herein by reference.

After retrieving the requested medical data, the next activity in method 800 is an activity 862 of displaying the medical data. In some examples, the requested medical data can be displayed to requestor 190 on a monitor 1106 (FIGS. 11 and 12). The displaying of the medical data can include transforming the medical data into a visual depiction and transmitting the visual depiction of the medical data to the requestor.

In various embodiments, transforming the medical data can involve combining the requested medical data with other information about the patient. In the same or different embodiment, transforming the medical data can include transforming the medical data from a machine readable format to a format readable by a human. For example, the data regarding an EKG scan can be transformed from the format used to compactly store the medical data to a visual depiction on monitor 1106 (FIGS. 11 and 12). In another example, the data transformed into a visual depiction can include patient information (such as name, sex, social security number, patient ID, primary physician, medical history, drug interactions, etc.), and the data can be transformed from a compact machine-readable format into human-readable text.

After displaying the medical data in activity 862, method 800 is complete. Method 800 can be repeated when another request for the same or different medical data from the same or different requestor is received by the computer system.

FIG. 11 illustrates a computer 1100 that is suitable for implementing at least a portion of an embodiment of computer system 100 (FIG. 1). Computer 1100 includes a chassis 1102 containing one or more circuit boards (not shown), a floppy disc drive 1112, a Compact Disc Read-Only Memory (CD-ROM) or Digital Video Disc (DVD) drive 1116, and a hard drive 1114. A representative block diagram of the elements included on the circuit boards inside chassis 1102 is shown in FIG. 12. A central processing unit (CPU) 1210 in FIG. 12 is coupled to a system bus 1214 in FIG. 12. In various embodiments, the architecture of CPU 1210 can be compliant with any of a variety of commercially distributed architecture families including the RS/6000 family, the Motorola 68000 family, or the Intel x86 family.

System bus 1214 also is coupled to memory 1208 that includes both read only memory (ROM) and random access memory (RAM). Non-volatile portions of memory 1208 or the ROM can be encoded with a boot code sequence suitable for restoring computer 1100 (FIG. 11) to a functional state after a system reset. In addition, memory 1208 can include microcode such as a Basic Input-Output System (BIOS). In some examples, memory 1208 can include storage component 110 (FIG. 1).

In the depicted embodiment of FIG. 12, various I/O devices such as a disk controller 1204, a graphics adapter 1224, a video controller 1202, a keyboard adapter 1226, a mouse adapter 1206, a network adapter 1220, and other I/O devices 1222 can be coupled to system bus 1214. Keyboard adapter 1226 and mouse adapter 1206 are coupled to a keyboard 1104 (FIGS. 11 and 12) and a mouse 1110 (FIGS. 11 and 12), respectively, of computer 1100 (FIG. 11). While graphics adapter 1224 and video controller 1202 are indicated as distinct units in FIG. 12, video controller 1202 can be integrated into graphics adapter 1224, or vice versa in other embodiments. Video controller 1202 is suitable for refreshing a monitor 1106 (FIGS. 11 and 12) to display images on a screen 1108 (FIG. 11) of computer 1100 (FIG. 11). Disk controller 1204 can control hard drive 1114 (FIGS. 11 and 12), floppy disc drive 1112 (FIGS. 11 and 12), and CD-ROM or DVD drive 1116 (FIGS. 11 and 12). In other embodiments, distinct units can be used to control each of these devices separately.

Although many other components of computer 1100 (FIG. 9) are not shown, such components and their interconnection are well known to those of ordinary skill in the art. Accordingly, further details concerning the construction and composition of computer 1100 and the circuit boards inside chassis 1102 (FIG. 11) need not be discussed herein.

When computer 1100 in FIG. 11 is running, for example, program instructions stored on a floppy disc in floppy drive 1112, on a CD-ROM or DVD in CD-ROM or DVD drive 1116, on hard drive 1114, or in memory 1208 (FIG. 12) are executed by CPU 1210 (FIG. 12). A portion of the program instructions, stored on these devices, can be suitable for carrying out methods 200 (FIG. 2), 400 (FIG. 4), 500 (FIG. 5), 700 (FIG. 7), and/or 800 (FIG. 8) as described previously with respect to FIGS. 1-10. Additionally, the devices can perform the methods, or portions thereof, in real time.

In some examples, a computer-readable medium can include two or more computer-readable media. For example, a computer-readable medium can include two or more CD-ROMs. For example, a first part of the program instructions can be stored on a first CD-ROM and a second part of the program instructions can be stored on a second CD-ROM. Similarly, a first part of the program instructions can be stored in memory of a first computer, and a second part of the program instructions can be stored in a memory of a second computer. In this example, the first computer and second computer can interact to carry out methods 200 (FIG. 2), 400 (FIG. 4), 500 (FIG. 5), 700 (FIG. 7), and/or 800 (FIG. 8).

Additionally, in some examples, all or a portion of the program instructions can be carried out using hardware or a combination of hardware and software. For example, one of more of methods 200 (FIG. 2), 400 (FIG. 4), 500 (FIG. 5), 700 (FIG. 7), and/or 800 (FIG. 8) or parts thereof can be executed by hardware configured or specifically designed to perform the activity or activities.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that activity 251-256 of FIG. 2, processes 361-362 of FIG. 3, activities 451-455 of FIG. 4, activities 551-554 of FIG. 5, activities 751-755 of FIG. 7, activities 851-862 of FIG. 8, or any element of FIG. 1 may be comprised of many different activities, procedures and may be performed by many different modules, in many different orders and that the foregoing discussion of certain of these embodiments does not necessarily represent a complete description of all possible embodiments. In other examples, computer 1100 in FIG. 11 can be replaced with a cluster or collection of computers. In still another example, protocols other than the HL7 Protocol can be used. For example, information (e.g., patient and provider) can be a patient demographics viewer (PDQ) information or patient identifier cross reference (PIX) information. In general, information can be obtained from any data source, whether compliant with the HL7 protocol or not.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method of accessing medical data from two or more data sources, the method comprising:
receiving a first request for first data about a first patient from a first requestor, the first request for the first data includes a request for information regarding at least one of a bone of the first patient, an organ of the first patient, or a body tissue of the first patient;
retrieving first access information about the first patient;
retrieving second access information about the first requestor;
determining whether to grant access to the first data by the first requestor at least partially based on the first access information and the second access information;
retrieving the first data from a first source of the two or more data sources; and
if the first requestor is granted access to the first data, transforming the first data into a visual depiction and transmitting the visual depiction of the first data to the first requestor,
wherein:
receiving the first request, retrieving the first access information, retrieving the second access information, determining whether to grant the access, retrieving the first data, transforming the first data, and transmitting the visual depiction are performed using a computer system.

2. The method of claim 1, further comprising:
receiving a second request for second data about a second patient from a second requestor, the second request for the second data includes a request for information regarding of at least one of a bone of the second patient, an organ of the second patient, or a body tissue of the second patient;
retrieving third access information about the second patient;
retrieving fourth access information about the second requestor;
determining whether to grant access to the second data by the second requestor at least partially based on the third access information and the fourth access information;
retrieving the second data from a second source of the two or more data sources; and
if the second requestor is granted access to the second data, transforming the second data into a visual depiction and transmitting the visual depiction of the second data to the second requestor.

3. The method of claim 1, wherein:
retrieving the first data is performed if the first requestor is granted access to the first data.

4. The method of claim 1, wherein:
determining whether to grant the access to the first data comprises:
applying one or more access rules to the first request to determine whether to grant the access.

5. The method of claim 4, wherein:
determining whether to grant the access to the first data further comprises:
applying one or more patient directives to determine whether to grant the access.

6. The method of claim 4, wherein:
applying the one or more access rules comprises:
determining whether a relationship exists between the first patient and the first requestor;
determining a role of the first requestor; and
determine whether to grant access to the first data at least partially based on the role the first requestor, the relationship between the first patient and the first requestor, and the location of the first requestor.

7. The method of claim 1, wherein:
receiving the first request for the first data comprises:
receiving the first request for X-ray data; and
the first data comprises the X-ray data.

8. The method of claim 1, wherein:
retrieving the first access information about the first patient comprises:
accessing second data about the first patient; and
extracting the first access information from the second data.

9. The method of claim 1, wherein:
retrieving the second access information about the first requestor comprises:
accessing the second data about the first requestor; and
extracting the second access information from the second data.

10. The method of claim 1, further comprising:
authenticating an identity of the first requestor.

11. The method of claim 1, further comprising:
if the first requestor is denied access to the first data, notifying the first requestor of the denial of access.

12. The method of claim 1, wherein:
transforming the first data into the visual depiction comprises:
transforming the first data from a machine readable format to a format readable by humans.

13. A method of providing a patient-provider index, the method comprising:
accessing first medical data for a first patient, the first medical data regarding one or more medical services provided to the first patient;
extracting first information from the first medical data, the first information regarding one or more first providers of the one or more medical services;
extracting second information from the first medical data, the second information regarding the first patient;
retrieving third information from the patient-provider index;
modifying the third information using the first information and the second information; and
storing the third information in the patient-provider index,
wherein:
accessing the first medical data, extracting the first information, extracting the second information, retrieving the third information, modifying the third information, and storing the third information are performed using a computer system.

14. The method of claim 13, further comprising:
after modifying the third information, displaying second medical data to a first requestor if the first requestor is granted access to the second medical data based on the third information.

15. The method of claim 13, wherein:
accessing the first medical data comprises:
receiving a message from a relationship data source, the message containing the first medical data.

16. The method of claim 13, further comprising:
accessing provider data regarding the provider of medical services;
extracting fourth information about the one or more first providers from the provider data;
modifying the third information using the fourth information.

17. The method of claim 13, wherein:
the first medical data comprises at least one of X-ray data or cardiac signal data.

18. The method of claim 13, wherein:
modifying the third information comprises:
correlating the first information with the second information to create a list of relationships between the one or more first providers and the first patient;
storing the third information comprises:
storing the list of relationships in the patient-provider index; and
the third information comprises the list of relationships.

19. An apparatus configured to access medical data from two or more medical data sources and display the medical data to a first requestor, the medical data comprises information regarding at least one of a bone, an organ, or a body tissue, the apparatus comprising:
a patient-provider index configured to store information about one or more patients, one or more medical providers, and one or more relationships between the one or more patients and the one or more medical providers;
an access control module configured to receive a first request for the medical data from the first requestor and further configured to transform the medical data into a visual depiction and transmit the visual depiction of the medical data to the first requestor if the first requestor is granted access to the medical data;
a rules index configured to store one or more rules governing the access to the medical data;
a rules engine module configured to define the one or more rules governing the access to the medical data and further configured to determine whether to grant the access to the medical data to the first requestor at least partially based on the one or more rules and the information stored in the patient-provider index;
a patient-provider correlation engine configured to determine the one or more relationships between the one or more patients and the one or more medical providers; and
a data retrieval module configured to retrieve the medical data from the two or more medical data sources.

20. The apparatus of claim 19, further comprising:
a login and validation module configured to receive login information from the first requestor and authenticate an identity of the first requestor.

21. The apparatus of claim 19, further comprising:
a relationship retrieval module configured to gather the information about one or more patients and the one or more medical providers from one or more relationship data sources.

22. A computer-readable medium that stores instructions executable by at least one processor, the computer-readable medium comprising:
instructions for receiving a first request for medical data from a first requestor, the medical data comprises information regarding at least one of a bone of one or more first patients, an organ of the one or more first patients, or a body tissue of the one or more first patients;
instructions for transforming the medical data into a visual depiction;
instructions for transmitting the visual depiction of the medical data to the first requestor if the first requestor is granted access to the medical data;
instructions for defining one or more rules governing the access to the medical data;
instructions for storing the one or more rules governing the access to the medical data;
instructions for determining one or more relationships between the one or more first patients and one or more medical providers;
instructions for determining whether to grant the access to the medical data to the first requestor at least partially based on the one or more rules and the one or more relationships between the one or more first patients and the one or more medical providers; and
instructions for retrieving the medical data from two or more medical data sources.
